(19) United States
(12) Patent Application Publication
(10) Pub. No.: US 2019/0176032 A1
(43) Pub. Date: Jun. 13, 2019

(54) Rotation Transmission Arrangement

(71) Applicant: Roto VR Limited, Stanmore, Middlesex (GB)

(72) Inventors: Gavin Waxkirsh, Stanmore Middlesex (GB); Elliott Myers, Stanmore Middlesex (GB)

(73) Assignee: Roto VR Limited, Stanmore, Middlesex (GB)

(21) Appl. No.: 16/301,040

(22) PCT Filed: May 10, 2017
(86) PCT No.: PCT/GB2017/051299

§ 371 Date: Nov. 13, 2018

(30) Foreign Application Priority Data
May 12, 2016 (GB) 1608367.7

(51) Int. Cl. A63F 13/24; G06F 3/01; G06F 3/0362; G06F 3/033

(52) U.S. Cl. CPC A63F 13/24; G06F 3/011; A63F 2300/8082; G06F 3/0334; G06F 3/0362

(57) ABSTRACT

A rotation transmission arrangement for a rotatable virtual reality apparatus provides for wired transfer of electrical signals between a stationary processor associated with the virtual reality apparatus and a rotatable user input or user output associated with the virtual reality apparatus, enabling a user of the virtual reality apparatus to experience a more immersive and authentic virtual reality experience.

### CROSS-REFERENCE TO RELATED APPLICATIONS

The present application claims priority to PCT International Patent Application No. PCT/GB2017/051299, filed May 10, 2017 and Great Britain Patent Application No. 1608367.7, filed on May 12, 2016, the disclosure of which are incorporated herein by reference.

### STATEMENT RE: FEDERALLY SPONSORED RESEARCH/DEVELOPMENT

Not Applicable

### FIELD OF THE INVENTION

This invention relates to a rotation transmission arrangement and in particular, to a rotation transmission arrangement for a rotatable virtual reality apparatus.

### BACKGROUND

In order to create a more immersive virtual reality experience, it is desirable for a virtual reality apparatus to be able to rotate a user in real space. For example, it is desirable for a user to be able to sit or stand on a virtual reality apparatus which is arranged to rotate the user clockwise or anticlockwise about an axis of rotation. The virtual reality apparatus may be arranged to rotate the user in dependence upon movement of a character, vehicle or other entity in a virtual reality environment, such as a game or film world. For instance, if the user's character turns 45° to the left in a game world, the virtual reality apparatus may be arranged to cause the user to turn 45° to the left in real space by rotating the part of the virtual reality apparatus on which the user sits or stands.

However, in order to experience or interact with the virtual reality environment, the user must typically use a virtual reality input and/or output device such as a headset or a hand-held or foot-operated controller. Although some such virtual reality devices are arranged to use wireless technologies to exchange the necessary data between a processing device such as a games console and the virtual reality devices, this can lead to inferior performance, as some wireless technologies do not provide adequate bandwidth for optimal rendering of a virtual reality environment. However, using wired technologies has the drawback that the user can become tangled in wires as he or she is rotated by the virtual reality apparatus during use. This distracts from the virtual reality experience and is potentially also dangerous.

It is also desirable for the virtual reality apparatus to be useable with a plurality of different gaming or film-playback platforms, such as a plurality of different consoles, desktop computers, DVD players, Blu-ray players or other devices which are stationary and located away from the virtual reality apparatus or on a non-moving part of the virtual reality apparatus. Virtual reality apparatus which can be used with only one platform are frustrating as they lead to redundant hardware and wasted space.

The invention aims to go some way towards ameliorating or solving these problems.

### BRIEF SUMMARY OF SOME EMBODIMENTS OF THE INVENTION

Accordingly there is provided a rotation transmission arrangement for a rotatable virtual reality apparatus, the arrangement including: a slip ring apparatus including a stationary part and a rotating part, the slip ring apparatus providing for transfer of electrical signals between a stationary processor associated with the virtual reality apparatus and a rotatable user input or user output associated with the virtual reality apparatus, via the stationary part and the rotating part; a hollow shaft for supporting a user support of the virtual reality apparatus, the hollow shaft being arranged to accommodate at least a portion of the rotating part of the slip ring apparatus within the hollow shaft; a base supporting the hollow shaft, and a bearing arrangement arranged to allow the hollow shaft and the rotating part of the slip ring apparatus to rotate relative to the base.

Advantageously, the rotation transmission arrangement allows electrical signals to be transferred, via one or more wires or cables, between a stationary processor associated with the virtual reality apparatus and a rotatable user input or user output associated with the virtual reality apparatus.

In some embodiments, the slip ring apparatus comprises a user-replaceable module arranged to be substantially fixed to one or more of the hollow shaft and the base supporting the hollow shaft. Preferably, the slip ring apparatus includes connectors for connecting the stationary processor associated with the virtual reality apparatus and the rotatable user input or user output associated with the virtual reality apparatus.

Advantageously, these features may allow a user of the rotation transmission arrangement to use the rotation transmission arrangement with a plurality of different types of virtual reality apparatus and/or with a plurality of different types of rotatable user input and/or user output associated with the respective different types of virtual reality apparatus. This may be achieved by providing the slip ring apparatus with different electrical connectors to suit the particular virtual reality apparatus which a user has chosen. By providing suitable male and female connector pairings, the slip ring apparatus may be inserted electrically in-line with the normal connection between the virtual reality apparatus and the stationary processor meaning that the virtual reality apparatus does not need to be specially designed to operate with the rotation transmission arrangement and the rotation transmission arrangement can be adapted for different types of virtual reality apparatus simply by swapping the slip ring apparatus for one having a different set connector types.

Preferably, the hollow shaft includes a shaft connector aperture arranged to allow the rotatable user input or user output associated with the virtual reality apparatus to be connected to one of the connectors of the slip ring apparatus. The shaft connector aperture advantageously permits parts of cables or wires to be inserted through a wall of the hollow shaft into one of the connectors of the slip ring apparatus.

Preferably, the base includes a base connector aperture arranged to allow the stationary processor associated with the virtual reality apparatus to be connected to one of the connectors of the slip ring apparatus.

In some embodiments, the rotation transmission arrangement additionally includes a motor arranged to cause rotation of the hollow shaft relative to the base. Preferably, an output of the motor is coupled to the hollow shaft via a rotational coupling. Advantageously this may allow rotation of a user relative to the base. This may allow the user to experience in the “real” world a rotation corresponding to a rotation experienced by, for example, a character in a film or game world. In some embodiments, the rotational coupling comprises a worm screw and a threaded ring.

Preferably, the rotation transmission arrangement additionally comprises a shaft slip ring apparatus holder arranged to substantially fix the orientation of the rotating part of the slip ring apparatus relative to the hollow shaft. The shaft slip ring apparatus holder and the hollow shaft may include respective apertures arranged to receive a fixing means to substantially fix the slip ring apparatus holder and the hollow shaft relative to one another. Advantageously, this may help prevent misalignment of components of the rotation transmission arrangement. Alternatively, or additionally, it may help ensure that the connectors for connecting the rotatable user input or user output associated with the virtual reality apparatus can always be accessed by a user. In some embodiments, the shaft slip ring apparatus holder comprises a pair of mutually engaging pieces of approximately semi-circular cross section.

Preferably, the rotation transmission arrangement additionally comprises a base slip ring apparatus holder arranged to substantially fix the orientation of the stationary part of the slip ring apparatus relative to the base. Advantageously, this may help prevent misalignment of components of the rotation transmission arrangement. Alternatively or additionally, it may help ensure that the connectors for connecting the stationary processor associated with the virtual reality apparatus can always be accessed by a user.

Preferably, the user support of the rotation transmission arrangement comprises one or more of: a chair, a stool, and a platform.

### BRIEF DESCRIPTION OF THE DRAWINGS

The accompanying drawings, which are incorporated in and constitute part of this specification, show embodiments of the invention for illustrative purposes only, that is to teach the invention to the skilled person so as to allow the skilled person to carry out the invention within the scope of the appended claims.

FIG. 1 schematically illustrates components of a rotation transmission arrangement according to an embodiment of the invention;

FIG. 2 schematically illustrates, in rear-side view, a rotation transmission arrangement according to an embodiment of the invention;

FIG. 3 schematically illustrates, in front-side view, a rotation transmission arrangement according to an embodiment of the invention;

FIG. 4 schematically illustrates, in side view, a rotation transmission arrangement according to an embodiment of the invention;

FIG. 5 schematically illustrates, in top view, a rotation transmission arrangement according to an embodiment of the invention;

FIG. 6 schematically illustrates, in under-side view, a rotation transmission arrangement according to an embodiment of the invention;

FIG. 7 schematically illustrates, in cross-sectional perspective view, a rotation transmission arrangement according to an embodiment of the invention;

FIG. 8 schematically illustrates, in cross-sectional side view, a rotation transmission arrangement according to an embodiment of the invention;

FIG. 9 schematically illustrates, in perspective view, a rotation transmission arrangement according to an embodiment of the invention; and

FIG. 10 schematically illustrates, in perspective under-side view, a rotation transmission arrangement according to an embodiment of the invention.

### DETAILED DESCRIPTION

The detailed description set forth below is intended as a description of the presently preferred embodiment of the invention, and is not intended to represent the only form in which the present invention may be implemented or performed. The description sets forth the functions and sequences of steps for practicing the invention. It is to be understood, however, that the same or equivalent functions and sequences may be accomplished by different embodiments and that they are also intended to be encompassed within the scope of the invention.

The present embodiments represent the best ways currently known to the applicant of putting the invention into practice, but they are not the only ways in which this can be achieved. They are illustrated, and they will now be described, by way of example only.

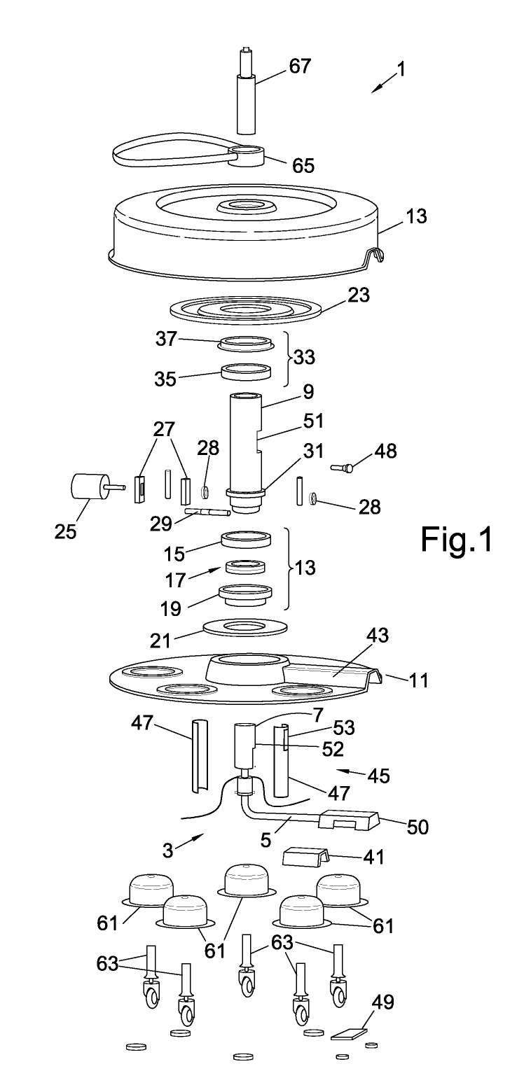

With reference to FIG. 1, a rotation transmission arrangement 1 for a rotatable virtual reality apparatus comprises a slip ring apparatus 3, the slip ring apparatus 3 including a stationary part 5 and a rotating part 7. The slip ring apparatus 3 provides for transfer of electrical signals between a stationary processor (not illustrated) associated with a virtual reality apparatus and a rotatable user input or user output (not illustrated) associated with the virtual reality apparatus.

The rotation transmission arrangement 1 also includes a hollow shaft 9. The hollow shaft 9 is arranged to support a user support of the virtual reality apparatus. The user support may be, for example, a chair, a stool or a platform, on which the user can sit or stand during use of the virtual reality apparatus. As illustrated in the example of FIG. 1, there may be a number of intervening components between the hollow shaft 9 and the user support, though in some examples the hollow shaft 9 may support the user support directly. The hollow shaft 9 may be made of metal or any other material of adequate strength for supporting a user support.

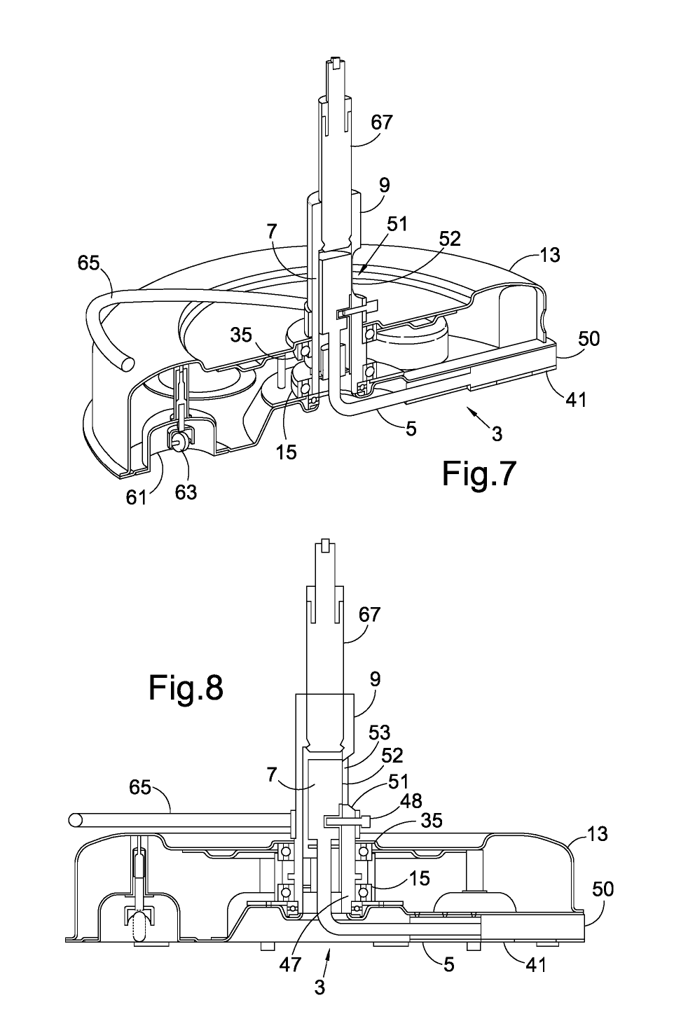

The hollow shaft 9 is arranged to accommodate at least a portion of the rotating part 7 of the slip ring apparatus 3. In particular, the hollow shaft 9 has a sufficiently wide bore and a sufficient length that it can accept at least a portion of the rotating part 7 of the slip ring apparatus 3. In the illustrated example, the hollow shaft 9 is arranged to accommodate all of the rotating part 7 of the slip ring apparatus 3, as can be seen in FIGS. 7 and 8. In the illustrated example, the hollow shaft 9 also accommodates a portion of the stationary part 5 of the slip ring apparatus 3, though this may not be the case in other examples.

The rotation transmission arrangement 1 also includes a base arranged to support the hollow shaft 9. The base may include or be formed of one or more parts. In the illustrated example, the base includes a metal base plate 11 and a metal top cover 13, though in other examples different components and different materials may be used. The base plate 11 and the top cover 13 may be affixed to one another, e.g. using screws or other fixing means.

In the illustrated example, the base houses a portion of the hollow shaft 9 and a number of other components. One of the other components housed by the base is a bearing arrangement 13. The bearing arrangement 13 includes a pair of bearing rings 15, 17 and a bearing bracket 19. The bearing arrangement 13 is arranged to allow the hollow shaft 9 and the rotating part 7 of the slip ring apparatus 3 to rotate relative to the base. The components of the bearing arrangement 13 may be made of any suitable materials. In the illustrated example, the bearing rings 15, 17 are made of metal and the bearing bracket 19 is made of plastic.

Other components housed by the base include a metal gear box bottom cover 21; a metal gear box upper cover 23; and a further bearing arrangement 33, including bearing ring 35 and bearing bracket 37. In the illustrated example the bearing ring 35 is a metal bearing ring and the bearing bracket 37 is a plastic bearing bracket. However, in other examples, the bearing ring 35 and the bearing bracket 37 may be made of other materials. The further bearing arrangement 33 may be arranged to allow the hollow shaft 9 and the rotating part 7 of the slip ring apparatus 3 to rotate relative to the base and/or to allow other parts of the rotation transmission arrangement 1 to rotate relative to each other. The metal gear box bottom cover 21 and/or the metal gear box upper cover 23 may be arranged such that other components of the arrangement 1 described above and below can be connected to the cover 21 or the cover 23 (such as the motor 25 discussed below).

The rotation transmission arrangement 1 also includes a motor 25 arranged to cause rotation of the hollow shaft 9 relative to the base. In the illustrated embodiment, the motor 25 is mounted on the gear box bottom cover 21 via two motor supports 27. An output of the motor 25 (such as a spindle) is coupled to the hollow shaft 9 via a rotational coupling. In the illustrated embodiment, the rotational coupling comprises a worm screw 29 and a threaded ring 31 which mesh with each other. The worm screw 29 is rotated by the motor output (spindle). Rotation of the motor spindle and/or the worm screw 29 is facilitated by one or more additional bearing arrangements, e.g. bearing arrangements including illustrated bearings 28.

The illustrated slip ring apparatus 3 comprises a user-replaceable module arranged to be substantially fixed to one or more of the hollow shaft 9 and the base supporting the hollow shaft 9. In particular, the slip ring apparatus 3 can be removed from the rotation transmission arrangement 1 and replaced with a different slip ring apparatus, as will be described in more detail in the following paragraphs.

When the slip ring apparatus 3 is installed in the rotation transmission arrangement 1, the stationary part 5 of the slip ring apparatus 3 may be substantially fixed to the base supporting the hollow shaft 9. In particular, the stationary part 5 may be substantially fixed to the base plate 11 using a base slip ring apparatus holder 41. The base slip ring apparatus holder 41 may fit around a portion of the stationary part 5 of the slip ring apparatus 3 and may hold the stationary part 5 substantially fixed in a groove or channel 43 of the base plate 11. The base slip ring apparatus holder 41 may substantially fix the orientation of the stationary part 5 of the slip ring apparatus 3 relative to the base.

Analogously, the rotating part 7 of the slip ring apparatus 3 may be substantially fixed to the hollow shaft 9 when the slip ring apparatus 3 is installed in the rotation transmission arrangement 1. In particular, the rotating part 7 may be substantially fixed to the hollow shaft 9 using a shaft slip ring apparatus holder 45. The shaft slip ring apparatus holder 45 may fit inside the hollow shaft 9 and may be arranged to substantially fix the orientation of the rotating part 7 of the slip ring apparatus 3 relative to the hollow shaft 9.

In the illustrated embodiment, the shaft slip ring apparatus holder 45 comprises a pair of mutually engaging pieces 47 of approximately semi-circular cross section. The two pieces 47 fit around the rotating part 7 and fit within the hollow shaft 9 to constrain the movement of the rotating part 7 relative to the hollow shaft 9.

In the illustrated embodiment, the shaft slip ring apparatus holder 45 and the hollow shaft 9 include respective apertures arranged to receive a fixing means (in the illustrated example, a screw 48) to substantially fix the slip ring apparatus holder 45 and the hollow shaft 9 relative to one another. This may ensure that axial movement of the shaft slip ring apparatus holder 45 relative to the hollow shaft 9 is constrained or prevented. This may consequently prevent axial movement of the slip ring apparatus 3 relative to the hollow shaft 9.

The slip ring apparatus 3 includes connectors 50, 52 for connecting the stationary processor associated with the virtual reality apparatus and the rotatable user input or user output associated with the virtual reality apparatus. In particular, the stationary part 5 includes a connector 50 arranged to connect to the stationary processor associated with the virtual reality apparatus, and the rotating part 7 includes a connector 52 arranged to connect to the rotatable user input or user output associated with the virtual reality apparatus.

The connectors 50, 52 may be sockets or plugs which are suitable for connection to specific devices. For example, the connector 50 may be a socket suitable for connecting to a specific games console, and the connector 52 may be a socket suitable for connecting to a specific virtual reality headset. The user may be able to replace the slip ring apparatus 3 with a different apparatus that includes different connectors, for connecting to different games consoles and/or a different virtual reality headset. This therefore enables the rotation transmission arrangement to be versatile and usable with various different hardware.

In order to replace the slip ring apparatus 3, the user may remove components which hold the slip ring apparatus 3 in position relative to the other components of the rotation transmission arrangement 1. For instance, the user may first remove a holding plate 49 (see FIG. 6), before being able to remove the base slip ring apparatus holder 41 holding the stationary part 5 of the slip ring apparatus 3 in place. The user may also need to remove one or more other components fixing the base slip ring apparatus holder 41 in place. The user will also need to remove the fixing means 48 arranged to substantially fix the slip ring apparatus holder 45 and the hollow shaft 9 relative to one another. When the user has removed all of the components fixing the slip ring apparatus 3 in place, the user may remove the slip ring apparatus 3 by, for example, pulling the slip ring apparatus 3 and the out of the bottom aperture of the hollow shaft 9. The user may then separate the two pieces 47 of the shaft slip ring apparatus holder 45 to release the slip ring apparatus 3 completely. The user may then be able to insert a different slip ring apparatus into the shaft slip ring apparatus holder 45, insert the shaft slip ring apparatus holder 45 and the new slip ring apparatus into the bottom aperture of the hollow shaft 9, and fix the slip ring apparatus 3 in place using the fixing components (e.g. the screw 48 and the plate 49).

As illustrated in FIG. 1, the hollow shaft 9 includes a shaft connector aperture 51 arranged to allow the rotatable user input or user output associated with the virtual reality apparatus to be connected to one of the connectors of the slip ring apparatus 3. In particular, the shaft connector aperture 51 in the illustrated embodiment allows the rotatable user input or user output to be connected to the connector 52 of the rotating part 7 of the slip ring apparatus 3. The shaft slip ring apparatus holder 45 also includes a holder aperture 53 arranged to align with the shaft connector aperture 51 and the connector 52 to allow the rotatable user input or user output associated with the virtual reality apparatus to be connected to the connector 52.

Analogously, base slip ring apparatus holder 41 may include a further holder aperture arranged to align with the connector 50 and with a base connector aperture in the base so that the stationary processor associated with the virtual reality apparatus can be connected to the slip ring apparatus 3.

The rotation transmission arrangement 1 may include further components, such as the wheel holders 61 which fit into corresponding wheel apertures in the base plate 11 and which accept wheels 63, to enable the rotation transmission arrangement 1 to be wheeled across a surface. In other examples, the rotation transmission arrangement 1 may instead include static feet or other supports instead of the wheels 63 and wheel holders 61. In that case, the base plate 11 may include apertures of a different size or shape, to enable the feet or other supports to be fixed to the base plate 11.

As illustrated in FIG. 1, a foot pedal 65 and pneumatic bar 67 may be provided above the main part of the rotation transmission arrangement 1. A user sitting on the user support of the virtual reality apparatus may be able to rest his or her feet on the foot pedal 65. In some embodiments, the foot pedal 65 may be equipped with user input or user output devices, such as pedals or vibration feedback outputs. The pneumatic bar 67 may be used to raise or lower the user support, relative to the base.

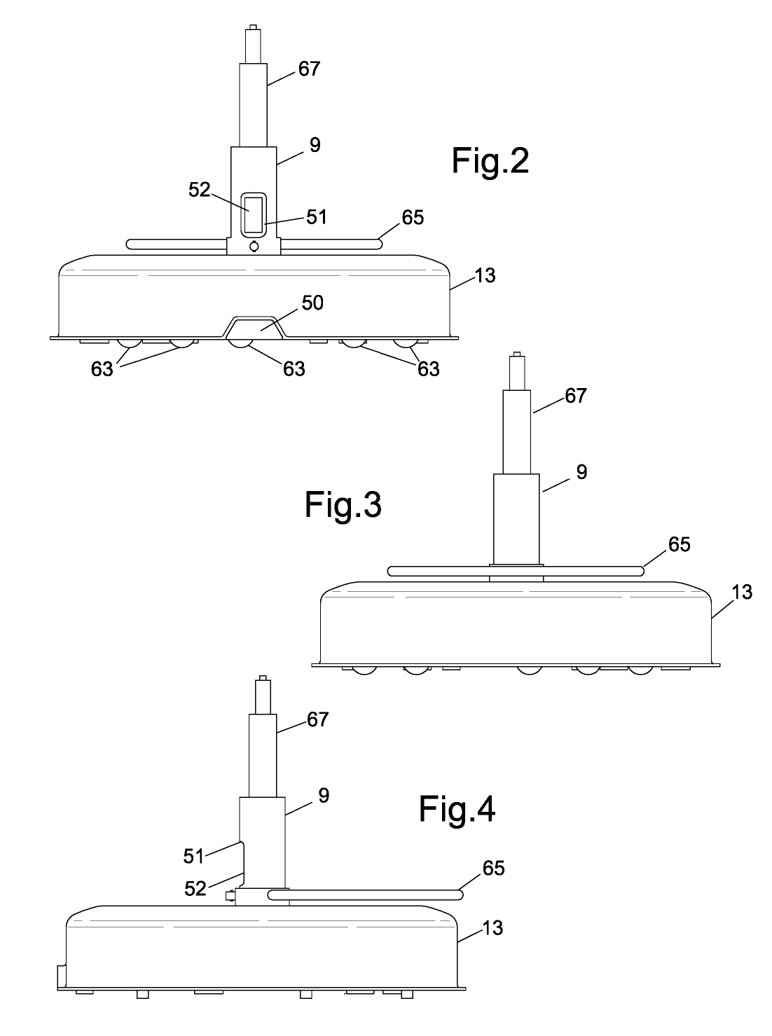

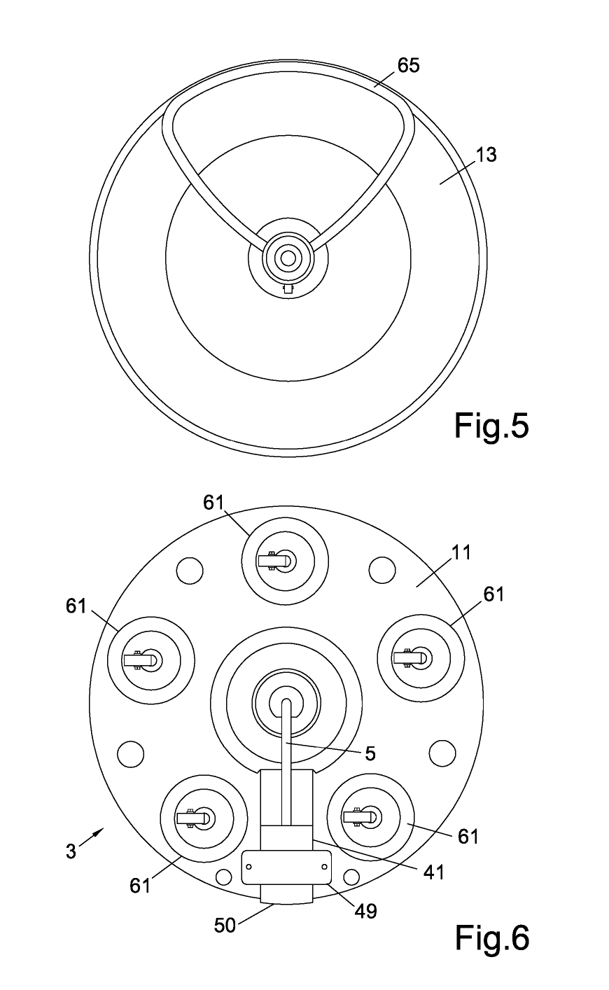

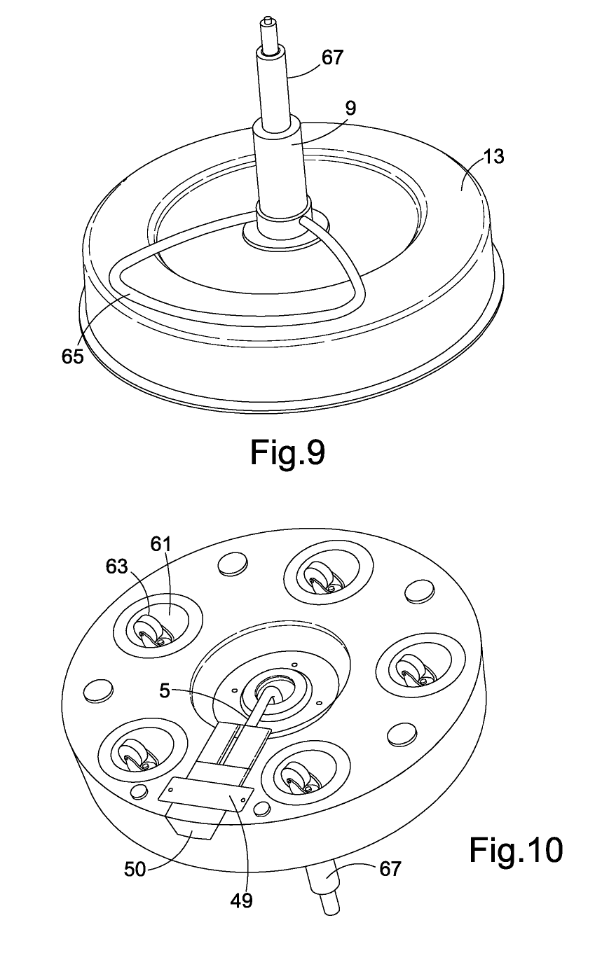

FIGS. 2-10 show assembled rotation transmission arrangements according to embodiments of the invention, in different orientations. In FIG. 6, for instance, which gives an under-side view of a rotation transmission arrangement, the relative positioning of the stationary part 5 of the slip ring apparatus 3, the base slip ring apparatus holder 41 and the holding plate 49 is illustrated. The positioning of the wheels 61 in the base part 11 can also be seen.

Although the rotation transmission arrangement has been described as being for a rotatable virtual reality apparatus, it may also be used in other contexts.

1. A rotation transmission arrangement for a rotatable virtual reality apparatus, the arrangement including:
a slip ring apparatus including a stationary part and a rotating part, the slip ring apparatus providing for transfer of electrical signals between a stationary processor associated with the virtual reality apparatus and a rotatable user input or user output associated with the virtual reality apparatus, via the stationary part and the rotating part;
a hollow shaft for supporting a user support of the virtual reality apparatus, the hollow shaft being arranged to accommodate at least a portion of the rotating part of the slip ring apparatus within the hollow shaft;
a base supporting the hollow shaft, and
a bearing arrangement arranged to allow the hollow shaft and the rotating part of the slip ring apparatus to rotate relative to the base.

2. A rotation transmission arrangement as claimed in claim 1, wherein the slip ring apparatus comprises a user-replaceable module arranged to be substantially fixed to one or more of the hollow shaft and the base supporting the hollow shaft.

3. A rotation transmission arrangement as claimed in claim 1, wherein the slip ring apparatus includes connectors for connecting the stationary processor associated with the virtual reality apparatus and the rotatable user input or user output associated with the virtual reality apparatus.

4. A rotation transmission arrangement as claimed in claim 3, wherein the hollow shaft includes a shaft connector aperture arranged to allow the rotatable user input or user output associated with the virtual reality apparatus to be connected to one of the connectors of the slip ring apparatus.

5. A rotation transmission arrangement as claimed in claim 3, wherein the base includes a base connector aperture arranged to allow the stationary processor associated with the virtual reality apparatus to be connected to one of the connectors of the slip ring apparatus.

6. A rotation transmission arrangement as claimed in any preceding claim additionally comprising a motor arranged to cause rotation of the hollow shaft relative to the base.

7. A rotation transmission arrangement as claimed in claim 6, wherein an output of the motor is coupled to the hollow shaft via a rotational coupling.

8. A rotation transmission arrangement as claimed in claim 7, wherein the rotational coupling comprises a worm screw and a threaded ring.

9. A rotation transmission arrangement as claimed in claim 1, additionally comprising a shaft slip ring apparatus holder arranged to substantially fix the orientation of the rotating part of the slip ring apparatus relative to the hollow shaft.

10. A rotation transmission arrangement as claimed in claim 9 wherein the shaft slip ring apparatus holder and the hollow shaft include respective apertures arranged to receive a fixing means to substantially fix the slip ring apparatus holder and the hollow shaft relative to one another.

11. A rotation transmission arrangement as claimed in claim 9 wherein the shaft slip ring apparatus holder comprises a pair of mutually engaging pieces of approximately semi-circular cross section.

12. A rotation transmission arrangement as claimed in claim 1, additionally comprising a base slip ring apparatus holder arranged to substantially fix the orientation of the stationary part of the slip ring apparatus relative to the base.

13. A rotation transmission arrangement as claimed in claim 1, wherein the user support comprises one or more of: a chair, a stool, and a platform.
